(19) United States
(12) Patent Application Publication
(10) Pub. No.: US 2017/0313870 A1
(43) Pub. Date: Nov. 2, 2017

(54) POLYCARBONATE-ABS BASED ALLOY RESIN COMPOSITION HAVING SUPERIOR PLATING ADHESION AND MOLDED ARTICLE INCLUDING THE SAME

(71) Applicant: LG CHEM, LTD., Seoul (KR)

(72) Inventors: Jae Hwan KIM, Daejeon (KR); Myeung II KIM, Daejeon (KR); Seok Jae YOO, Daejeon (KR); Sung Ho LEE, Daejeon (KR); Sung Tae AHN, Daejeon (KR); Min Ho JEONG, Daejeon (KR)

(21) Appl. No.: 15/516,274

(22) PCT Filed: Sep. 26, 2016
(86) PCT No.: PCT/KR2016/010744

§ 371 Date: Mar. 31, 2017

(30) Foreign Application Priority Data
Nov. 5, 2015 (KR) 10-2015-0154968

(51) Int. Cl. C08L 55/02; C08L 51/04; C08L 25/12; C08L 69/00; C08J 5/00

(52) U.S. Cl. CPC C08L 55/02; C08L 69/00; C08J 5/00; C08L 25/12; C08L 51/04

(57) ABSTRACT

The present disclosure relates to a polycarbonate-ABS based alloy resin composition having superior plating adhesion and a molded article manufactured therefrom.

In accordance with the present disclosure, a polycarbonate-ABS based alloy resin composition having superior plating adhesion as well as superior mechanical properties, and a molded article including the polycarbonate-ABS based alloy resin composition.

### TECHNICAL FIELD

### CROSS-REFERENCE TO RELATED APPLICATION(S)

This application claims the priority benefit of Korean Patent Application No. 10-2015-0154968, filed on November 05, 2015 in the Korean Intellectual Property Office, the disclosure of which is incorporated herein by reference.

The present disclosure relates to a polycarbonate-ABS based alloy resin composition having superior plating adhesion and a molded article including the same, and more particularly to a polycarbonate-ABS based alloy resin composition having superior mechanical properties, particularly superior low-temperature impact strength, as well as improved plating adhesion, and a molded article including the same.

### BACKGROUND ART

Plastic plating is widely used because it provides a metal-like appearance and improves rigidity, heat resistance, abrasion resistance and the like. In particular, acrylonitrile-butadiene-styrene (hereinafter referred to as ABS) resin is widely used as a plastic for plating because it can be treated with chromic acid and sulfuric acid and provides satisfactory plating properties.

ABS resin is widely used in various products, such as automotive products, electrical and electronic products, and office equipment, due to the stiffness and chemical resistance of acrylonitrile, the processability of butadiene and styrene, and the mechanical strength and aesthetics of the ABS resin.

Butadiene rubber of an ABS resin is oxidized by an etchant, such as chromic acid or sulfuric acid, thereby providing anchor holes. Accordingly, stable adsorption of a metal thereto can be guaranteed, and mechanical anchoring effect provided by a metallic film embedded in the anchor holes allows high adhesion compared to general plastic resins. Such high plating adhesion of an ABS resin has led to the active development of plastic plating.

However, when an ABS resin is plated, the plated ABS resin suffers decreased impact strength and heat resistance, compared to before plating with the ABS resin. To address such a problem, a PC/ABS resin prepared by blending an ABS resin with a polycarbonate resin is used as a plastic for plating. However, in this case, problems, such as non-plating or peeling off of a metal from a plated plastic, occur due to content decrease of the ABS resin.

Therefore, there is a need for development of a plastic for plating which provides superior impact resistance and heat resistance as well as superior plating adhesion.

### RELATED ART DOCUMENT

[Patent Document] KR 0989907 B1

### DISCLOSURE

### Technical Problem

Therefore, the present invention has been made in view of the above problems, and it is one object of the present invention to provide a polycarbonate-ABS based alloy resin composition having superior plating adhesion as well as superior mechanical properties, and a molded article including the polycarbonate-ABS based alloy resin composition.

The above and other objects can be accomplished by the present invention described below.

### Technical Solution

In accordance with an aspect of the present invention, the above and other objects can be accomplished by the provision of a polycarbonate-ABS based alloy resin composition with superior plating adhesion including (a) 35 to 75% by weight of a polycarbonate resin; (b) 5 to 35% by weight of a copolymer prepared by polymerizing a conjugated diene rubber having an average particle diameter of 0.6 to 1.5 μm, an aromatic vinyl compound, and a vinyl cyanide compound; (c) 5 to 20% by weight of a copolymer prepared by polymerizing a conjugated diene rubber having an average particle diameter of 0.2 μm or more and less than 0.6 μm, an aromatic vinyl compound, and a vinyl cyanide compound; (d) 5 to 20% by weight of a copolymer prepared by polymerizing a conjugated diene rubber having an average particle diameter of 0.1 to 0.3 μm, an aromatic vinyl compound, and a (meth)acrylate compound; and (e) 0 to 40% by weight of an aromatic vinyl compound-vinyl cyanide compound copolymer, and a method of preparing the polycarbonate-ABS based alloy resin composition.

In accordance with another aspect of the present invention, there is provided a molded article manufactured from the polycarbonate-ABS based alloy resin composition having superior plating adhesion.

### Advantageous Effects

As apparent from the above description, the present disclosure provides a polycarbonate-ABS based alloy resin composition providing increased plating adhesion and superior mechanical properties, particularly superior low-temperature impact strength, due to increase in surface roughness of an alloy of a polycarbonate resin and ABS-based resin, and a molded article including the same.

### BEST MODE

Hereinafter, the present disclosure is described in detail.

A polycarbonate-ABS based alloy resin composition having superior plating adhesion according to the present disclosure includes (a) 35 to 75% by weight of a polycarbonate resin; (b) 5 to 35% by weight of a copolymer prepared by polymerizing a conjugated diene rubber having an average particle diameter of 0.6 to 1.5 μm, an aromatic vinyl compound, and a vinyl cyanide compound; (c) 5 to 20% by weight of a copolymer prepared by polymerizing a conjugated diene rubber having an average particle diameter of 0.2 μm or more and less than 0.6 μm, an aromatic vinyl compound, and a vinyl cyanide compound; (d) 5 to 20% by weight of a copolymer prepared by polymerizing a conjugated diene rubber having an average particle diameter of 0.1 to 0.3 μm, an aromatic vinyl compound, and a (meth)acrylate compound; and (e) 0 to 40% by weight of an aromatic vinyl compound-vinyl cyanide compound copolymer. Within this range, superior plating adhesion, as well as superior mechanical properties, is provided.

Hereinafter, each ingredient of the polycarbonate-ABS based alloy resin composition having superior plating adhesion of the present disclosure is described in detail.

(a) Polycarbonate Resin

The polycarbonate resin (a) is not specifically limited and, for example, may be a resin prepared by polymerizing a bisphenol-based monomer and a carbonate precursor.

The bisphenol-based monomer may be one or more selected from the group consisting of, for example, bis(4-hydroxyphenyl)methane, bis(4-hydroxyphenyl)ether, bis(4-hydroxyphenyl)sulfone, bis(4-hydroxyphenyl)sulfoxide, bis(4-hydroxyphenyl)sulfide, bis(4-hydroxyphenyl)ketone, 1,1-bis(4-hydroxyphenyl)ethane, 2,2-bis(4-hydroxyphenyl)propane(bisphenol A (BPA)), 2,2-bis(4-hydroxyphenyl)butane, 1,1-bis(4-hydroxyphenyl)cyclohexane(bisphenol Z (BPZ)), 2,2-bis(4-hydroxy-3,5-dibromophenyl)propane, 2,2-bis(4-hydroxy-3,5-dichlorophenyl)propane, 2,2-bis(4-hydroxy-3-bromophenyl)propane, 2,2-bis(4-hydroxy-3-chlorophenyl)propane, 2,2-bis(4-hydroxy-3-methylphenyl)propane, 2,2-bis(4-hydroxy-3,5-dimethylphenyl)propane, 1,1-bis(4-hydroxyphenyl)-1-phenylethane, bis(4-hydroxyphenyl)diphenylmethane, and α, ω-bis[3-(o-hydroxyphenyl)propyl]polydimethylsiloxane.

The carbonate precursor may be one or more selected from the group consisting of, for example, dimethyl carbonate, diethyl carbonate, dibutyl carbonate, dicyclohexyl carbonate, diphenyl carbonate, ditolyl carbonate, bis(chlorophenyl) carbonate, m-cresyl carbonate, dinaphthyl carbonate, bis(diphenyl) carbonate, carbonyl chloride(phosgene), triphosgene, diphosgene, carbonyl bromide, and bishaloformate.

The amount of the polycarbonate resin (a) may be, for example, 35 to 75% by weight, 40 to 70% by weight, or 45 to 65% by weight. Within this range, superior heat resistance and impact strength are provided.

The weight-average molecular weight of the polycarbonate resin (a) may be, for example, 20,000 to 80,000 g/mol, 40,000 to 75,000 g/mol, or 50,000 to 70,000 g/mol. Within this range, superior impact strength, satisfactory fluidity, and superior processabililty may be obtained.

The polycarbonate resin (a) may have, for example, a melt index (300° C., 1.2 kg) of 3 to 70 g/10 min, 15 to 50 g/10 min, or 25 to 60 g/10 min which is measured according to ASTM D1238. Within this range, superior processabililty and excellent property balance are provided.

(b) Copolymer Prepared by Polymerizing Conjugated Diene Rubber having Average Particle Diameter of 0.6 to 1.5 μm, Aromatic Vinyl Compound, and Vinyl Cyanide Compound

The amount of the copolymer (b) may be, for example, 7 to 25% by weight, or 10 to 20% by weight. Within this range, superior mechanical properties, such as superior tensile strength and impact strength, and excellent heat deflection temperature and plating adhesion are provided.

The average particle diameter of the conjugated diene rubber may be, for example, 0.8 to 1.4 μm, or 1.0 to 1.3 μm. Within this range, superior plating adhesion and impact strength are provided.

The copolymer (b) may be prepared by, for example, polymerizing 5 to 20% by weight of a conjugated diene rubber, 60 to 80% by weight of an aromatic vinyl compound, and 10 to 30% by weight of a vinyl cyanide compound. Alternatively, the copolymer (b) may be prepared by, for example, polymerizing 10 to 15% by weight of a conjugated diene rubber, 65 to 75% by weight of an aromatic vinyl compound, and 15 to 25% by weight of a vinyl cyanide compound. In this case, superior mechanical properties and property balance are provided.

(c) Copolymer Prepared by Polymerizing Conjugated Diene Rubber having Average Particle Diameter of 0.2 μm or More and Less Than 0.6 μm, Aromatic Vinyl Compound, and Vinyl Cyanide Compound

The amount of the copolymer (c) may be, for example, 7 to 17% by weight, or 10 to 15% by weight. Within this range, superior plating adhesion and processabililty are provided.

The conjugated diene rubber may have an average particle diameter of, for example, 0.2 μm to 0.5 μm, or 0.3 to 0.5 μm. Within this range, superior plating adhesion is provided.

The copolymer (c) may be prepared by polymerizing, for example, 50 to 70% by weight of a conjugated diene rubber, 20 to 40% by weight of an aromatic vinyl compound, and 5 to 20% by weight of a vinyl cyanide compound. Alternatively, the copolymer (c) may be prepared by polymerizing, for example, 50 to 65% by weight of a conjugated diene rubber, 25 to 35% by weight of an aromatic vinyl compound, and 10 to 15% by weight of a vinyl cyanide compound. In this case, superior mechanical properties and property balance are provided.

In the polycarbonate-ABS based alloy resin composition according to the present disclosure including the copolymers (b) and (c) prepared by respectively polymerizing conjugated diene rubbers, average particle diameters of which are different, particles having different average particle diameters are present. Accordingly, surface roughness increases and thus plating adhesion is further increased.

(d) Copolymer Prepared by Polymerizing Conjugated Diene Rubber having Average Particle Diameter of 0.1 to 0.3 μm, Aromatic Vinyl Compound, and (Meth)Acrylate Compound

The amount of the copolymer (d) may be, for example, 5 to 17% by weight, or 5 to 13% by weight. Within this range, superior plating adhesion is provided.

The average particle diameter of the conjugated diene rubber may be, for example, 0.15 to 0.25 μm, or 0.20 to 0.25 μm. Within this range, superior plating adhesion is provided.

The (meth)acrylate compound of the copolymer (d) may be, for example, alkylmethacrylate. In a specific embodiment, the alkylmethacrylate may be one or more selected from the group consisting of methyl methacrylate, butyl methacrylate, and benzyl methacrylate.

The copolymer (d) may be, for example, a core-shell graft copolymer including 60 to 80% by weight or 65 to 75% by weight of a core and 20 to 40% by weight or 25 to 35% by weight of a shell. Within this range, increased impact strength and processabililty are provided.

A total content of the copolymers (b), (c), and (d) may be, for example, 20 to 50% by weight, 25 to 45% by weight, or 30 to 40% by weight. Within this range, superior plating adhesion and low-temperature impact strength are provided.

(e) Aromatic Vinyl Compound-Vinyl Cyanide Compound Copolymer

The amount of the copolymer (e) may be, for example, 0 to 40% by weight, 10 to 30% by weight, or 5 to 25% by weight. Within this range, superior tensile strength is provided.

The copolymer (e) may be prepared by polymerizing, for example, 60 to 85% by weight or 70 to 80% by weight of an aromatic vinyl compound and 15 to 40% by weight or 20 to 30% by weight of a vinyl cyanide compound. Within this range, superior mechanical properties and property balance are provided.

The conjugated diene rubber of the present disclosure may be a rubber prepared by polymerizing one or more selected from the group consisting of, for example, 1,3-butadiene, 2,3-dimethyl-1,3-butadiene, 2-ethyl-1,3-butadiene, 1,3-pentadiene, and isoprene.

The aromatic vinyl compound of the present disclosure may be one or more selected from the group consisting of, for example, styrene, α-methylstyrene, o-ethylstyrene, p-ethylstyrene, and vinyltoluene.

The vinyl cyanide compound of the present disclosure may be one or more selected from the group consisting of, for example, acrylonitrile, methacrylonitrile, and ethacrylonitrile.

The polycarbonate-ABS based alloy resin composition further includes one or more selected from the group consisting of, for example, an antimicrobial agent, a thermal stabilizer, an antioxidant, a releasing agent, a photostabilizer, a surfactant, a coupling agent, a plasticizer, an admixture, a colorant, a stabilizer, a lubricant, an antistatic agent, a toning agent, a flame retardant, a weather resistant agent, an ultraviolet absorber, and a sunscreen agent.

The polycarbonate resin composition may have an impact strength of, for example, 30 kgf·cm/cm or more, or 30 to 45 kgf·cm/cm which is measured at −30° C. according to ASTM D256.

The polycarbonate resin composition may have a plating adhesion of, for example, 7.0 N/cm or more, 8.0 N/cm or more, or 8.0 to 12 N/cm.

A method of manufacturing the polycarbonate-ABS based alloy resin composition having superior plating adhesion according to the present disclosure may include, for example, a step of melt-mixing (a) 35 to 75% by weight of a polycarbonate resin; (b) 5 to 35% by weight of a copolymer prepared by polymerizing a conjugated diene rubber having an average particle diameter of 0.6 to 1.5 μm, an aromatic vinyl compound, and a vinyl cyanide compound; (c) 5 to 20% by weight of a copolymer prepared by polymerizing a conjugated diene rubber having an average particle diameter of 0.2 μm or more and less than 0.6 μm, an aromatic vinyl compound, and a vinyl cyanide compound; (d) 5 to 20% by weight of a copolymer prepared by polymerizing a conjugated diene rubber having an average particle diameter of 0.1 to 0.3 μm, an aromatic vinyl compound, and a (meth)acrylate compound; and (e) 0 to 40% by weight of an aromatic vinyl compound-vinyl cyanide compound copolymer, followed by extrusion.

The melt-mixing may be carried out, for example, at 220 to 290° C., or 230 to 260° C.

In addition, the present disclosure provides a molded article manufactured using the polycarbonate-ABS based alloy resin composition of the present disclosure.

Now, the present invention will be described in more detail with reference to the following preferred examples. However, these examples are provided for illustrative purposes only. Those skilled in the art will appreciate that various modifications, additions and substitutions are possible, without departing from the scope and spirit of the invention. Therefore, it is obvious that the modifications, additions and substitutions are within the scope of the present invention.

### EXAMPLES

Compounds used in examples and comparative examples below are as follows:

PC: Polycarbonate having a weight-average molecular weight of 44,000 g/mol and a melt index of 15 g/10 min.

Large particle diameter ABS: Copolymer prepared by polymerizing 10% by weight of a butadiene rubber having an average particle diameter of 1.0 μm, 70% by weight of styrene, and 20% by weight of acrylonitrile.

Small particle diameter ABS: Copolymer prepared by polymerizing 60% by weight of a butadiene rubber having an average particle diameter of 0.3 μm, 30% by weight of styrene, and 10% by weight of acrylonitrile.

MBS-1: Copolymer prepared by polymerizing 70% by weight of a butadiene rubber having an average particle diameter of 0.2 μm, as an ingredient of a core, and 20% by weight of acrylate and 10% by weight of styrene, as ingredients of a shell.

MBS-2: Copolymer prepared by polymerizing 70% by weight of butadiene rubber having an average particle diameter of 0.1 μm, as an ingredient of a core, and 20% by weight of acrylate and 10% by weight of styrene, as ingredients of a shell.

MBS-3: Copolymer prepared by polymerizing 70% by weight of a butadiene rubber having an average particle diameter of 0.4 μm, as an ingredient of a core, and 20% by weight of acrylate and 10% by weight of styrene, as ingredients of a shell.

SAN: Copolymer prepared by polymerizing 75% by weight of styrene and 25% by weight of an acrylonitrile copolymer.

### Examples 1 to 5 and Comparative Examples 1 to 10

Respective ingredients summarized in Tables 1 and below were added in amounts disclosed in the tables, followed by mixing by means of a mixer. Subsequently, each of the resultant mixtures was extruded at 230 to 260° C. by means of a twin-screw extruder and then pelletized. The formed pellets were dried at 80° C. for 4 hours or more and then injection molded. As a result, a specimen was obtained. The obtained specimen was allowed to stand at room temperature for 48 hours and then subjected to property measurement.

### Test Example

The properties of the polycarbonate-ABS based alloy resin composition prepared according to each of

Examples 1 to 5 and Comparative Examples 1 to 10 were measured according to the following methods. Results are summarized in Tables 1 and 2 below.

Tensile strength (kgf/cm²): Measured according to ASTM D638.

Impact strength (¼,kgf·cm/cm): Measured at 23° C. and −30° C. according to ASTM D256.

Heat deflection temperature (° C.): Measured according to ASTM D648.

Plating adhesion (N/cm): A 10×10 square specimen was injected after melt extruding. The injected specimen was plated and then was subjected to a 90° peel adhesion test by intentionally peeling off some of the plating.

Average particle diameter: Measured by means of a particle size analyzer, NICOMP 380.

Weight-average molecular weight (g/mol): A sample was dissolved in tetrahydrofuran (THF) and then the weight-average molecular weight thereof was measured using GPC.

TABLE 1

| | | | | | | Com- | Com- |
|---|---|---|---|---|---|---|---|
| | Ex- | Ex- | Ex- | Ex- | Ex- | par- | par- |
| | am- | am- | am- | am- | am- | ative | ative |
| Classi- | ple | ple | ple | ple | ple | Exam- | Exam |
| fication | 1 | 2 | 3 | 4 | 5 | ple 1 | ple 2 |
| PC | 45 | 65 | 50 | 45 | 45 | 45 | 45 |
| Large | 10 | 10 | 20 | 15 | 12 | 30 | 30 |
| particle | | | | | | | |
| diameter | | | | | | | |
| ABS | | | | | | | |
| Small | 10 | 10 | 10 | 7 | 14 | 15 | — |
| particle | | | | | | | |
| diameter | | | | | | | |
| ABS | | | | | | | |
| MBS-1 | 10 | 10 | 10 | 12 | 6 | — | 15 |
| SAN | 25 | 5 | 0 | 21 | 23 | 10 | 10 |
| Tensile | 420 | 410 | 400 | 415 | 417 | 420 | 425 |
| strength | | | | | | | |
| Impact | 48 | 57 | 53 | 50 | 49 | 49 | 48 |
| strength | | | | | | | |
| (23° C.) | | | | | | | |
| Impact | 30 | 35 | 32 | 31 | 31 | 32 | 30 |
| strength | | | | | | | |
| (−30° C.) | | | | | | | |
| Heat | 99 | 108 | 103 | 100 | 100 | 98 | 99 |
| deflection | | | | | | | |
| temper- | | | | | | | |
| ature | | | | | | | |
| Plating | 8.0 | 9.0 | 8.8 | 8.2 | 8.1 | 4.5 | 4.0 |
| adhesion | | | | | | | |

TABLE 2

| | Compar- | Compar- | Compar- | Compar- | Compar- | Compar- | Compar- | Compar- |
|---|---|---|---|---|---|---|---|---|
| | ative | ative | ative | ative | ative | ative | ative | ative |
| | Exam- | Exam- | Exam- | Exam- | Exam- | Exam- | Exam- | Exam- |
| | ple | ple | ple | ple | ple | ple | ple | ple |
| Classification | 3 | 4 | 5 | 6 | 7 | 8 | 9 | 10 |
| PC | 30 | 80 | 45 | 45 | 45 | 45 | 45 | 45 |
| Large | 15 | 5 | — | — | — | 50 | 10 | 10 |
| particle | | | | | | | | |
| diameter | | | | | | | | |
| ABS | | | | | | | | |
| Small | 15 | 5 | 11 | 25 | — | — | 10 | 10 |
| particle | | | | | | | | |
| diameter | | | | | | | | |
| ABS | | | | | | | | |
| MBS-1 | 15 | 5 | 10 | — | 20 | — | — | — |
| MBS-2 | — | — | — | — | — | — | 10 | — |
| MBS-3 | — | — | — | — | — | — | — | 10 |
| SAN | 25 | 5 | 34 | 30 | 35 | 5 | 25 | 25 |
| Tensile | 380 | 460 | 420 | 420 | 430 | 460 | 415 | 425 |
| strength | | | | | | | | |
| Impact | 30 | 60 | 48 | 47 | 45 | 42 | 45 | 50 |
| strength | | | | | | | | |
| (23° C.) | | | | | | | | |
| Impact | 14 | 22 | 26 | 25 | 28 | 17 | 28 | 31 |
| strength | | | | | | | | |
| (−30° C.) | | | | | | | | |
| Heat | 85 | 117 | 98 | 98 | 99 | 99 | 99 | 98 |
| deflection | | | | | | | | |
| temperature | | | | | | | | |
| Plating | 3.8 | 2.0 | 4.0 | 2.3 | 2.0 | 1.5 | 5.5 | 6.0 |
| adhesion | | | | | | | | |

As summarized in Tables 1 and 2, the polycarbonate-ABS based alloy resin compositions (Examples to 5) according to the present disclosure exhibit superior tensile strength and impact strength, particularly superior low-temperature impact strength and low-temperature heat deflection temperature, as well as superior plating adhesion.

On the other hand, in the case of the resin composition of Comparative Example 5 which does not include an ABS copolymer polymerized with butadiene having a large particle diameter, low-temperature impact strength and plating adhesion are decreased. In the cases of the resin composition of Comparative Example 1 not including an MBS resin and the resin composition of Comparative Example 2 including an ABS copolymer polymerized with butadiene having a small particle diameter, plating adhesion is decreased.

In addition, in the case of the resin composition of Comparative Example 3 including a small amount of polycarbonate, mechanical properties, such as tensile strength and impact strength, heat deflection temperature, and plating adhesion are deteriorated. In the case of the resin composition of Comparative Example 4 including a large amount of polycarbonate, low-temperature impact strength and plating adhesion are greatly decreased.

In addition, in the case of the resin compositions of Comparative Examples 6 to 8 which do not include any one of an ABS copolymer polymerized with butadiene having a large particle diameter, an ABS copolymer polymerized with butadiene having a small particle diameter, and an MBS resin, impact strength, particularly low-temperature impact strength is very low and plating adhesion is very poor.

Further, in the case of the resin compositions of Comparative Examples 9 and 10 including an MBS polymerized with a butadiene rubber, the average particle diameter of which is outside the range of 0.1 to 0.3 μm, mechanical properties are maintained, but plating adhesion is decreased.

1. A polycarbonate-ABS based alloy resin composition, comprising:
(a) 35 to 75% by weight of a polycarbonate resin;
(b) 5 to 35% by weight of a copolymer prepared by polymerizing a conjugated diene rubber having an average particle diameter of 0.6 to 1.5 μm, an aromatic vinyl compound, and a vinyl cyanide compound;
(c) 5 to 20% by weight of a copolymer prepared by polymerizing a conjugated diene rubber having an average particle diameter of 0.2 μm or more and less than 0.6 μm, an aromatic vinyl compound, and a vinyl cyanide compound;
(d) 5 to 20% by weight of a copolymer prepared by polymerizing a conjugated diene rubber having an average particle diameter of 0.1 to 0.3 μm, an aromatic vinyl compound, and a (meth)acrylate compound; and
(e) 0 to 40% by weight of an aromatic vinyl compound-vinyl cyanide compound copolymer.

2. The polycarbonate-ABS based alloy resin composition according to claim 1, wherein the polycarbonate resin (a) has a weight-average molecular weight of 20,000 to 80,000 g/mol.

3. The polycarbonate-ABS based alloy resin composition according to claim 1, wherein a total amount of the copolymer (b), the copolymer (c), and the copolymer (d) is 20 to 50% by weight.

4. The polycarbonate-ABS based alloy resin composition according to claim 1, wherein the copolymer (b) is prepared by polymerizing 5 to 20% by weight of a conjugated diene rubber, 60 to 80% by weight of an aromatic vinyl compound, and 10 to 30% by weight of a vinyl cyanide compound.

5. The polycarbonate-ABS based alloy resin composition according to claim 1, wherein the copolymer (c) is prepared by polymerizing 50 to 70% by weight of a conjugated diene rubber, 20 to 40% by weight of an aromatic vinyl compound, and 5 to 20% by weight of a vinyl cyanide compound.

6. The polycarbonate-ABS based alloy resin composition according to claim 1, wherein the (meth)acrylate compound comprised in the copolymer (d) is alkylmethacrylate.

7. The polycarbonate-ABS based alloy resin composition according to claim 1, wherein the copolymer (d) is a core-shell graft copolymer comprising 60 to 80% by weight of a core and 20 to 40% by weight of a shell.

8. The polycarbonate-ABS based alloy resin composition according to claim 1, wherein the aromatic vinyl compound-vinyl cyanide compound copolymer (e) is prepared by polymerizing 60 to 85% by weight of an aromatic vinyl compound and 15 to 40% by weight of a vinyl cyanide compound.

9. The polycarbonate-ABS based alloy resin composition according to claim 1, wherein the conjugated diene rubber is prepared by polymerizing one or more selected from the group consisting of 1,3-butadiene, 2,3-dimethyl-1,3-butadiene, 2-ethyl-1,3-butadiene, 1,3-pentadiene, and isoprene.

10. The polycarbonate-ABS based alloy resin composition according to claim 1, wherein the aromatic vinyl compound is one or more selected from the group consisting of styrene, a-methylstyrene, o-ethylstyrene, p-ethylstyrene, and vinyltoluene.

11. The polycarbonate-ABS based alloy resin composition according to claim 1, wherein the vinyl cyanide compound is one or more selected from the group consisting of acrylonitrile, methacrylonitrile, and ethacrylonitrile.

12. The polycarbonate-ABS based alloy resin composition according to claim 6, wherein the alkylmethacrylate is one or more selected from the group consisting of methyl methacrylate, butyl methacrylate, and benzyl methacrylate.

13. The polycarbonate-ABS based alloy resin composition according to claim 1, further comprising one or more selected from the group consisting of an antimicrobial agent, a thermal stabilizer, an antioxidant, a releasing agent, a photostabilizer, a surfactant, a coupling agent, a plasticizer, an admixture, a colorant, a stabilizer, a lubricant, an antistatic agent, a toning agent, a flame retardant, a weather resistant agent, an ultraviolet absorber, and a sunscreen agent.

14. The polycarbonate-ABS based alloy resin composition according to claim 1, wherein the polycarbonate resin composition has an impact strength of 30 kgf·cm/cm or more which is measured at −30° C. according to ASTM D256.

15. The polycarbonate-ABS based alloy resin composition according to claim 1, wherein the polycarbonate resin composition has a plating adhesion of 7.0 N/cm or more.

16. A method of manufacturing a polycarbonate-ABS based alloy resin composition, the method comprising a step of melt-mixing (a) 35 to 75% by weight of a polycarbonate resin; (b) 5 to 35% by weight of a copolymer prepared by polymerizing a conjugated diene rubber having an average particle diameter of 0.6 to 1.5 μm, an aromatic vinyl compound, and a vinyl cyanide compound; (c) 5 to 20% by weight of a copolymer prepared by polymerizing a conjugated diene rubber having an average particle diameter of 0.2 μm or more and less than 0.6 μm, an aromatic vinyl compound, and a vinyl cyanide compound; (d) 5 to 20% by weight of a copolymer prepared by polymerizing a conjugated diene rubber having an average particle diameter of 0.1 to 0.3 μm, an aromatic vinyl compound, and a (meth)acrylate compound; and (e) 0 to 40% by weight of an aromatic vinyl compound-vinyl cyanide compound copolymer, followed by extrusion.

17. A molded article manufactured using the polycarbonate-ABS based alloy resin composition according to claim 1.
